(19) United States
(12) Patent Application Publication
(10) Pub. No.: US 2026/0218385 A1
(43) Pub. Date: Jul. 30, 2026

(54) A METHOD FOR PROCESSING A BODY OF POLYCRYSTALLINE DIAMOND MATERIAL

(71) Applicant: Element Six (UK) Limited, Didcot, Oxfordshire (GB)

(72) Inventors: David Thomas FORD, Harwell, Oxfordshire (GB); David William ALDMINGTON, Harwell, Oxfordshire (GB); Carmen Elena ZVORISTE-WALTERS, Harwell, Oxfordshire (GB); Jonathan James BIDDULPH, Harwell, Oxfordshire (GB)

(21) Appl. No.: 19/143,605

(22) PCT Filed: Dec. 22, 2023
(86) PCT No.: PCT/EP2023/087609

§ 371 Date: Jun. 26, 2025

(30) Foreign Application Priority Data
Dec. 31, 2022 (GB) 2219869.1
Dec. 31, 2022 (GB) 2219870.9
Dec. 31, 2022 (GB) 2219871.7
Dec. 31, 2022 (GB) 2219872.5
Dec. 31, 2022 (GB) 2219873.3
Dec. 31, 2022 (GB) 2219875.8
Dec. 31, 2022 (GB) 2219876.6
Dec. 31, 2022 (GB) 2219877.4
Dec. 31, 2022 (GB) 2219878.2
Dec. 31, 2022 (GB) 2219879.0
Dec. 31, 2022 (GB) 2219880.8
Dec. 31, 2022 (GB) 2219881.6
Dec. 31, 2022 (GB) 2219882.4

(51) Int. Cl. C23F 4/00; E21B 10/567

(52) U.S. Cl. CPC C23F 4/00; E21B 10/567

(57) ABSTRACT

A method for leaching a polycrystalline diamond cutter element is disclosed as providing a leaching receptacle having a first cavity and a second cavity therein. A volume of liquid acid leaching mixture is introduced into the second cavity. The PCD cutter element is attached to a fixture and a seal member is positioned around a portion of the PCD cutter element and located in a recess in the fixture. The PCD cutter element is located in the second cavity. The fixture is connected to the leaching receptacle, compressing the seal member against and/or between the cutter and the leaching receptacle to form a closed system with the PCD cutter to be leached in the fixture forming a lid. The temperature of the liquid acid leaching mixture is elevated to above ambient conditions to leach at least a portion of the PCD cutter element.

This disclosure relates to a method for processing a body of polycrystalline diamond (PCD) material and a PCD construction so processed.

### BACKGROUND

Cutter inserts for machining and other tools may typically comprise a layer of polycrystalline diamond (PCD) material bonded to a cemented carbide substrate. PCD is an example of a superhard material, also called a superabrasive material, which has a hardness value substantially greater than that of cemented tungsten carbide.

Components comprising PCD are used in a wide variety of tools for cutting, machining, drilling or degrading hard or abrasive materials such as rock, metal, ceramics, composites and wood-containing materials. PCD comprises a mass of substantially inter-grown (inter-bonded) diamond grains forming a skeletal mass, which define interstices between the diamond grains. PCD material typically comprises at least about 80 volume % of diamond and may be made by subjecting an aggregated mass of diamond grains to an ultra-high pressure of greater than about 5 GPa, typically about 5.5 GPa or more, and temperature of at least about 1200° C., typically about 1440° C., in the presence of a sintering aid, also referred to as a solvent catalyst material for diamond. Solvent catalyst materials for diamond are understood to be materials capable of promoting direct inter-growth of diamond grains at a pressure and temperature condition at which diamond is thermodynamically more stable than graphite.

Examples of solvent catalyst materials for diamond are cobalt, iron, nickel and certain alloys including alloys of any of these elements. PCD may be formed, for example, on a cobalt-cemented tungsten carbide substrate, which may provide a source of cobalt catalyst material for the PCD. During sintering of the body of PCD material, a constituent of the cemented carbide substrate, such as cobalt from a cobalt cemented tungsten carbide substrate, liquefies and sweeps from a region adjacent the volume of diamond particles into interstitial regions between the diamond particles. In this example, the cobalt acts as a solvent catalyst to facilitate the formation of bonded diamond grains. Optionally, a metal-solvent catalyst may be mixed with diamond particles prior to subjecting the diamond particles and substrate to the HPHT process. The interstices within PCD material may at least partly be filled with the solvent catalyst material. The intergrown (inter-bonded) diamond structure therefore comprises original diamond grains as well as a newly precipitated or re-grown diamond phase, which bridges the original grains. In the final sintered structure, solvent catalyst material generally remains present within at least some of the interstices that exist between the sintered diamond grains.

Sintered PCD typically has sufficient wear resistance and hardness for use in aggressive wear, cutting and drilling applications however a well-known problem experienced with this type of PCD compact or cutting element is that the presence of residual solvent catalyst material in the microstructural interstices may have a detrimental effect on the performance of the PCD compact at high temperatures as it is believed that the presence of the solvent catalyst in the diamond table reduces the thermal stability of the diamond table at these elevated temperatures. For example, the difference in thermal expansion coefficient between the diamond grains and the residual solvent/catalyst is believed to lead to chipping or cracking in the PCD table of a cutting element during drilling or cutting operations where operating temperatures may reach 700 degrees C. or more. The chipping or cracking in the PCD material may degrade the mechanical properties of the cutting element or lead to failure of the cutting element. Additionally, at high temperatures, diamond grains may undergo a chemical breakdown or back-conversion with the solvent catalyst. At extremely high temperatures, portions of diamond grains may transform to carbon monoxide, carbon dioxide, graphite, or combinations thereof, thereby degrading the mechanical properties of the PCD material.

A potential solution to these problems is to remove residual solvent catalyst (also known as binder phase) from the PCD material.

Chemical leaching is often used to remove metal solvent catalyst, such as cobalt, from interstitial regions of a body of PCD material, for example from regions adjacent the working surfaces of the PCD. It is typically extremely difficult and time consuming to remove effectively the bulk of a metallic solvent catalyst from a PCD table, particularly from the thicker PCD tables required by current applications. In general, current art is focused on achieving PCD of high diamond density and commensurately PCD that has an extremely fine distribution of metal solvent catalyst pools. This fine network typically resists penetration by the leaching agents, such that residual solvent catalyst often remains behind in the leached compact. Furthermore, achieving appreciable leaching depths can take so long as to be commercially unfeasible or require undesirable interventions such as extreme acid treatment or physical drilling of the PCD tables.

A common approach for removing the catalyst from a PCD material is to leach the PCD material to remove some or substantially all the interstitial catalyst from the PCD lattice structure, thereby transforming the PCD material into a more thermally stable polycrystalline diamond material. Leaching typically involves placing the cutter element in a strong acid bath at an elevated temperature to expose the PCD table to the acid. Typical suitable acids for leaching include nitric acid, sulfuric acid, hydrofluoric acid, hydrochloric acid, and combinations thereof. Although such leaching acids can aid in removing the catalyst from the PCD material, they can also damage the underlying substrate to which the PCD table is secured and appropriate sealing is required to protect the substrate from such damage. Conventional leaching techniques using an acid bath are relatively time-consuming and it may take days or weeks to remove a sufficient quantity of the residual solvent catalyst from the PCD material. This increases the overall time, and associated costs, to manufacture cutter elements and fixed cutter drill bits into which such cutters are located in use.

There is therefore a need to overcome or substantially ameliorate the above-mentioned problems through a method for treating or processing a body of PCD material.

### SUMMARY

Viewed from a first aspect there is provided a method for leaching a polycrystalline diamond (PCD) cutter element having a non-diamond phase comprising a solvent catalyst material, the method comprising:
(a) providing a leaching receptacle having a first cavity therein and a second cavity therein, the first cavity extending from a first end of the leaching receptacle to a first open end of the second cavity, the second cavity extending from the first open end to a second end and being arranged to receive a volume of liquid acid leaching mixture;
(b) introducing a volume of liquid acid leaching mixture into the second cavity of the leaching receptacle;
(c) attaching the PCD cutter element to a fixture, the fixture being adapted to hold the PCD cutter element to be leached;
(d) positioning a seal member around a portion of the PCD cutter element to be leached; and locating the seal member in a recess in the fixture;
(e) locating the PCD cutter element in the second cavity by passing the PCD cutter element attached to the fixture through the first end of the leaching receptacle and through the first cavity;
(f) connecting the fixture to the leaching receptacle, the step of connecting comprising compressing the seal member against and/or between the cutter and the leaching receptacle to form a closed system with the PCD cutter to be leached in the fixture forming a lid; and
(g) elevating the temperature of the liquid acid leaching mixture to above ambient conditions to leach at least a portion of the PCD cutter element.

Viewed from a second aspect there is provided a polycrystalline diamond construction treated according to the above-defined method.

### BRIEF DESCRIPTION OF THE DRAWINGS

Various versions will now be described in more detail, by way of example, with reference to the accompanying figures in which:

FIG. 1 is a schematic perspective view of a PCD cutter insert for a cutting drill bit for boring into the earth;

FIG. 2 is a schematic cross section view of a portion of the PCD cutter insert of FIG. 1 showing the microstructure of the PCD material in the PCD cutter insert of FIG. 1 prior to processing;

FIG. 3 is a schematic partial cross-sectional view of an example of an apparatus for use in leaching a PCD cutter element according to an example method; and

FIG. 4 is a schematic flow chart illustrating an example of a method for leaching a PCD cutter element in accordance with the principles disclosed herein.

The same reference numbers refer to the same respective features in all drawings.

### DESCRIPTION

The instant disclosure is directed to methods of processing superabrasive articles, such as superabrasive cutting elements, superabrasive bearings, and superabrasive discs. The superabrasive articles disclosed herein may be used in a variety of applications, such as drilling tools (e.g. compacts, cutting elements, gage trimmers, etc.), machining equipment, bearing apparatuses, wire-drawing machinery, and other apparatuses.

As used herein, a “superhard material” also known as a “superabrasive” material is a material having a Vickers hardness of at least about 28 GPa. Diamond and cubic boron nitride (cBN) materials are examples of superhard or superabrasive materials.

As used herein, a “superhard construction” or “superabrasive construction” means a construction or compact comprising a body of polycrystalline superhard or superabrasive material. In such a construction, a substrate may be attached thereto or alternatively the body of polycrystalline material may be free-standing and unbacked.

As used herein, polycrystalline diamond (PCD) is a type of polycrystalline superhard (PCS) material comprising a mass of diamond grains, a substantial portion of which are directly inter-bonded with each other and in which the content of diamond is at least about 80 volume percent of the material. In one example of PCD material, interstices between the diamond grains may be at least partly filled with a binder material comprising a solvent catalyst for diamond. As used herein, “interstices” or “interstitial regions” are regions between the diamond grains of PCD material. In examples of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

A “catalyst material” for a superhard material is capable of promoting the growth or sintering of the superhard material.

The term “substrate” as used herein means any substrate over which the superhard material layer is formed. For example, a “substrate” as used herein may be a transition layer formed over another substrate.

As used herein, the term “integrally formed” regions or parts are produced contiguous with each other and are not separated by a different kind of material.

The term “molar concentration” as used herein, may refer to a concentration in units of mol/L at a temperature of approximately 25 [deg.] C. For example, a solution comprising solute A at a molar concentration of 1 M may comprise 1 mol of solute A per litre of solution.

As used herein, the term “depth of leaching” or “leach depth” refers to the distance into the PCD cutter element, from the outer surface thereof, to which the leaching acid has penetrated during the leaching process to remove residual solvent catalyst therefrom.

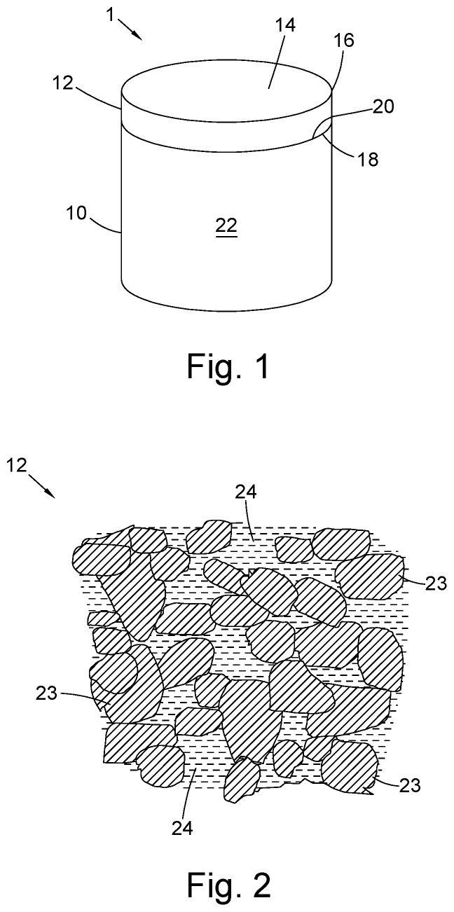

In an example as shown in FIG. 1, a cutting element 1 includes a substrate 10 with a body of PCD material 12 in the form of a layer formed on the substrate 10. The substrate 10 may be formed of a hard material such as cemented tungsten carbide. The cutting element 1 may be mounted into a bit body such as a drag bit body (not shown) and may be suitable, for example, for use as a cutter insert for a drill bit for boring into the earth.

The exposed top surface of the superhard material opposite the substrate forms the cutting face 14, which is the surface which, along with its edge 16, performs the cutting in use.

At one end of the substrate 10 is an interface surface 18 that forms an interface with the body of PCD material 12 which is attached thereto at this interface surface. As shown in the example of FIG. 1, the substrate 10 is generally cylindrical and has a peripheral surface 22 and a peripheral top edge 20.

As used herein, a PCD grade is a PCD material characterized in terms of the volume content and size of diamond grains, the volume content of interstitial regions between the diamond grains and composition of material that may be present within the interstitial regions. A grade of PCD material may be made by a process including providing an aggregate mass of diamond grains having a size distribution suitable for the grade, optionally introducing catalyst material or additive material into the aggregate mass, and subjecting the aggregated mass in the presence of a source of catalyst material for diamond to a pressure and temperature at which diamond is more thermodynamically stable than graphite and at which the catalyst material is molten. Under these conditions, molten catalyst material may infiltrate from the source into the aggregated mass and is likely to promote direct intergrowth between the diamond grains in a process of sintering, to form a PCD structure. The aggregate mass may comprise loose diamond grains or diamond grains held together by a binder material and said diamond grains may be natural or synthesized diamond grains.

Different PCD grades may have different microstructures and different mechanical properties, such as elastic (or Young's) modulus E, modulus of elasticity, transverse rupture strength (TRS), toughness (such as so-called K_{IC} toughness), hardness, density and coefficient of thermal expansion (CTE). Different PCD grades may also perform differently in use. For example, the wear rate and fracture resistance of different PCD grades may be different.

All of the PCD grades may comprise interstitial regions filled with material comprising cobalt metal, which is an example of solvent catalyst material for diamond.

The PCD structure 12 may comprise one or more PCD grades.

FIG. 2 is a cross-section through a body of PCD material which may form the super hard layer 12 of FIG. 1 in an example cutter element 1. During formation of a conventional polycrystalline diamond construction, the diamond grains 23 are directly interbonded to adjacent grains and the interstices 24 between the diamond grains 23 may be at least partly filled with a non-super hard phase material. This non-super hard phase material, also known as a filler material, may comprise residual solvent catalyst material, for example cobalt, nickel or iron.

In accordance with some examples, a sintered body of PCD material 12 is created having diamond to diamond bonding and having a second phase comprising solvent catalyst material dispersed through at least a portion of its microstructure. The body of PCD material 12 and attached substrate 10 which form the cutter element 1 may be formed according to standard methods, using HPHT conditions to produce a sintered compact. For example, a PCD layer 12 may formed by subjecting a plurality of diamond particles (e.g. diamond particles having an average particle size between approximately 0.5 μm and approximately 150 μm) to an HPHT sintering process in the presence of a metal solvent catalyst, such as cobalt, nickel, iron, and/or any other suitable group VIII element. During the HPHT sintering process, adjacent diamond grains in a mass of diamond particles may become bonded to one another, forming a PCD table (body of PCD material 12) comprising interbonded diamond grains. In one example, diamond grains in table 12 may have an average grain size of approximately 20 μm or less. Additionally, during an HPHT sintering process, diamond grains may become bonded to the adjacent substrate 10 at the interface 18.

In various examples, the substrate 10 is formed of a cemented tungsten carbide material and after sintering, the resulting body of PCD material 12 may include tungsten and/or tungsten carbide in addition to the diamond grains and residual solvent catalyst material. For example, tungsten and/or tungsten carbide may be swept into the PCD layer 12 from the substrate 10 during HPHT sintering as liquefied solvent catalyst from the substrate 10 (e.g. cobalt from a cobalt-cemented tungsten carbide substrate) may dissolve and/or carry tungsten and/or tungsten carbide from the substrate 10 into the mass of diamond particles used to form the PCD table 12 during the HPHT sintering. In additional examples, tungsten and/or tungsten carbide particles may be intentionally mixed with diamond particles prior to forming the body of PCD material 12.

It has been found that the removal of non-binder phase from within the PCD table, conventionally referred to as leaching, is desirable in various applications. One reason for this is that the presence of residual solvent catalyst material in the microstructural interstices is believed to have a detrimental effect on the performance of PCD compacts at high temperatures as it is believed that the presence of the solvent catalyst in the diamond table reduces the thermal stability of the diamond table at these elevated temperatures.

To improve the performance and heat resistance of a surface region of the body of PCD material 12, at least a portion of the metal-solvent catalyst, such as cobalt, is to be removed from the interstices 24 of at least a portion of the body of PCD material 12. Additionally, in some examples, tungsten and/or tungsten carbide may be removed from at least a portion of the body of PCD material 12.

Chemical leaching is typically used to remove residual solvent catalyst from the body of PCD material 12 either up to a desired depth from an external surface of the body of PCD material or from substantially all of the PCD material 12. Following leaching, the body of PCD material 12 may therefore comprise a first volume that is substantially free of solvent catalyst material. However, small amounts of solvent catalyst material may remain within interstices that are inaccessible to the leaching process. Additionally, following leaching, the body of PCD material 12 may also comprise a volume or region that contains solvent catalyst material. In some examples, this further volume may be remote from one or more exposed surfaces of the body of PCD material 12.

The interstitial material which may include, for example, the metal solvent catalyst and one or more additions in the form of carbide additions, may be leached from the interstices 24 in the body of PCD material 12 by exposing the PCD material to an example leaching mixture for example in liquid or vapour form.

The PCD region 12 of the PCD compacts 1 to be leached using examples of the method typically, but not exclusively, may have a thickness of about 1.5 mm to about 4 mm.

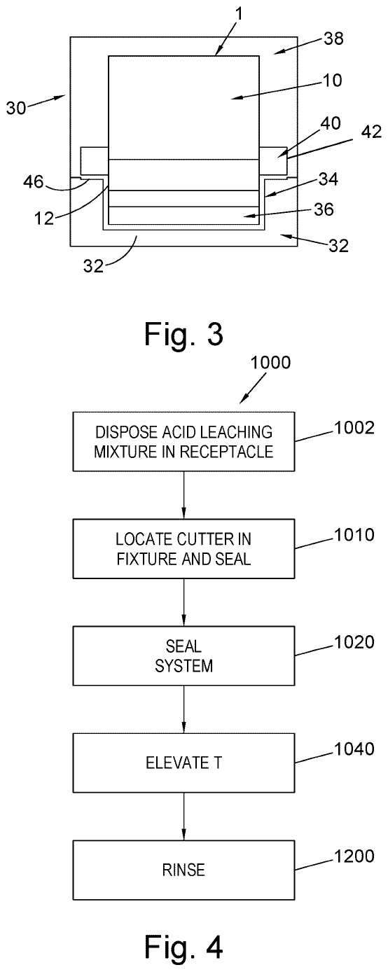

FIG. 3 is a schematic partial cross-sectional view of an apparatus 30 for use in an example method of processing of a PCD cutter element 1 to leach residual solvent catalyst from at least a portion thereof. The apparatus 30 includes a leaching receptacle 32 having a cavity 33 therein into which a liner 34 may be located. In some examples the liner may be a removable acid resistant liner or a fixed coating to protect the interior walls defining the cavity 33 in the leaching receptacle 32 from the leaching acid mixture disposed within the receptacle. In general, the liner 34 may be made of any material suitable for use with leaching acid mixtures over extended periods of time at the relatively high temperatures experienced during the leaching process described in more detail below. Examples of suitable materials for the liner 34 may include, without limitation, fluropolymers such as PTFE.

The PCD cutter element 1 to be leached is locatable in a fixture 38. In the example of FIG. 3, the fixture 38 has an aperture therein into which the cutter to be leached is inserted. The outer peripheral side surface of the fixture 38 has a threaded portion 39 for threaded engagement with a correspondingly threaded portion 42 in an open end of the leaching receptacle 32. A seal member 40 is locatable around the free end of the cutter 1 to be leached, at a location adjacent the body of PCD material 12 to be leached, to protect the substrate 10 of the cutter 1 during the treatment process, and to assist in achieving the desired leach profile within the body of PCD material. Once located in the fixture 38, a portion of the surface of the body of PCD material 12 of the cutter element 1 is left protruding from the open end of the fixture 38 for exposure to the acid leaching mixture 36.

A volume of liquid acid leaching mixture 36 is inserted into the leaching receptacle 32. The fixture 38 with the PCD cutter element 1 attached is then located in the leaching receptacle 32 with the exposed free end of the body of PCD material 12 facing the leaching mixture 36, and the fixture 38 is secured to the leaching receptacle 32 through mutual engagement of the threaded portions 39, 42 of the fixture 38 and leaching receptacle 32. If the process to be used is a vapour leaching process the PCD cutter element 1 is suspended above the acid leaching mixture 36 and spaced therefrom. If an aqueous leaching process is to be used the exposed portion of the cutter element 1 is inserted into the aqueous leaching mixture 36 contained in the leaching receptacle 32. The leaching receptacle 32 is sealed to the top fixture 38 thereby providing a closed system.

A threaded coupling or connection 39, 42 between the fixture 38 and leaching receptacle 32 may have the advantage of providing an evenly distributed load during the assembly process and throughout the leaching cycle. However, alternative mechanical mechanisms may be used and, in some examples, the threaded connection may be replaced with another mechanical locking mechanism to connect the top fixture 38 to the leaching receptacle 32 to close the system 30 such as a clamping or bolted mechanism. The leaching receptacle 32 may have a first cavity region 50 and a second cavity region 52, the first cavity region 50 extending from a first open end through which the fixture 38 is inserted to a first end of the second cavity region 52, and the second cavity region 52 extending from the first end to the base of the cavity 33 into which the leaching mixture 36 is placed, the cavity 33 forming the second cavity region 52. The first end of the second cavity region 52 is terminated in an annular flange 54 against which the fixture 38 is seated in the assembled condition. The threaded section 42 of the leaching receptacle 32 is located in the wall defining a portion of the first cavity region 50 extending from the flange 54. The peripheral outer side surface 60 of the fixture 38 may be spaced from the inner wall 62 defining the first cavity region 50 to enable a tool to be located around the fixture 38 to tighten or loosen the fixture 38 when engaging or disengaging the fixture with or from the leaching receptacle 32.

In some examples, a movable plug 70 may be introduced into a further recess 72 located in the base of leaching receptacle 32 and in some examples in which a removable liner 76 is inserted into the cavity 33, the plug 70 may be used to push the removable liner 76 out of the receptacle 32 for cleaning purposes.

In some examples the seal member 40 around the PCD cutter element 1 is an o-ring seal that extends around a peripheral side portion of the PCD cutter element 1 to protect the substrate 10 thereof from the acid vapour(s). Such a seal member 40 may provide both mechanical and chemical protection of the unexposed parts of the PCD cutter element 1 from the acid vapours and may be used also to control the form of leach profile obtained in the body of PCD material 12. Example materials which may be suitable for forming the seal member 40 may include a fluroelastomer such as a fluorinated, carbon-based rubber (including for example a Viton™ o-ring which is a VI780 grade of FKM). Other examples include but are not limited to those made of perfluoroelastomeric compounds (FFKM).

As shown in FIG. 3, in the closed system configuration, the seal member 40 is disposed in an annular groove 43 proximate the free open end of the fixture 38, to form an annular seal around the peripheral outer side surface of the body of PCD material 12. The annular groove 43 may be shaped to assist in compression of the seal member 40, and for example may be a stepped or tapered groove which may also assist in increasing the pressure exerted by the seal member 40 against the cutter element 1 and/or against the annular flange portion 54 in the assembled configuration. The seal member 40 also contacts the leaching receptacle 32 at the join with the fixture 38 to provide an additional sealing mechanism to the system 30 in the assembled configuration.

Also as shown in the example of FIG. 3, in which a vapour leaching process is to be used to leach the cutter element 1, the fixture 38 suspends the PCD cutter element 1 above the acid leaching mixture 36, the PCD material 12 of the cutter element 1 facing the acid leaching mixture 36 but being spaced therefrom. In an example where an aqueous leaching technique is to be used, the fixture 38 may be positioned such that a portion of the cutter element 1 is disposed in the aqueous acid leaching mixture 36 rather than being spaced therefrom.

Suitable acid leaching mixtures 36 for use in the system 30 may include, for example, an acid leaching mixture comprising any one or more of hydrochloric (HCl) acid, hydrofluoric (HF) acid, nitric (HNO₃) acid, sulfuric (H₂SO₄) acid, and/or phosphoric (H₃PO₄) acid. In some examples any one or more of said acids may have a molar concentration of between around 4M to around 9M and water. In some examples the acid leaching mixture 36 may comprise hydrofluoric acid at a molar concentration of between around 4M to around 9M, nitric acid at a molar concentration of between around 4M to around 9M, and water. In still further examples, an acid leaching mixture 36 comprising hydrofluoric acid at a molar concentration of between around 5 M to around 7M, nitric acid at a molar concentration of between around 6.7M to around 8M and water may be used. The water may be de-ionized water. In some examples, the hydrofluoric acid comprises between around 10 vol % to around 30 vol % of the acid mixture, the nitric acid or other acid(s) comprises between around 30 vol % to around 60 vol % of the acid mixture, and the water forms between around 20 to around 50 vol % of the mixture.

One or both of the fixture 38 and leaching receptacle 32 may be formed, for example, of stainless steel or may be made out of any suitable material capable of withstanding the high temperatures within the leaching receptacle 32 during the example leaching process described in more detail below.

FIG. 4 is a flow diagram of an exemplary method 1000 for processing a body of PCD material 12. The method 1000 will be described as being performed with the system 30 previously described, however, it should be appreciated that the method 1000 may be performed with other suitable vessel(s) while still complying with the principles disclosed herein. As illustrated in this figure, and as indicated at 1002, to treat the PCD cutter element to leach residual solvent catalyst from at least a portion thereof, a liquid acid mixture 36 is disposed within the cavity 33 in the leaching receptacle 32. The acid leaching mixture 36 is poured into the leaching receptacle 32 to a level below the open end 46 thereof. The acid leaching mixture may be any suitable acid for leaching a body of PCD material including, without limitation, any of the leaching acid mixtures previously described. At stage 1010 a PCD cutter element 1 is located in the fixture 38 and the seal member 40 is positioned around a portion of the outer peripheral side surface of the body of PCD material to be leached. Stage 1010 may occur before or after stage 1002. In stage 1020, the fixture 38 holding the PCD cutter element 1 is attached to the leaching receptacle 32 through the threaded connection of this example, resulting in partial compression of the seal member 40 to further seal the apparatus. In the illustrated example, in the closed configuration, the cutter element 1 is suspended within the leaching receptacle 32 above the liquid acid mixture 36 and spaced therefrom such the cutter element 1 does not contact the liquid acid mixture 36. In stage 1040 the temperature within the leaching receptacle 32 is elevated such that at least a portion of the acid mixture 36 begins to vaporize and leach the body of PCD material 12 of the cutter element 1. The substrate 10 of the cutter element 1 is protected from the leaching acid vapour(s) by the seal member 40 or other suitable means.

In stage 1040 of method 1000, the elevated temperature within the leaching receptacle 32 is maintained for a period of time to enable leaching of the body of PCD material to the desired leach depth to be achieved. As shown in FIG. 3, the body of PCD material to be leached is at least partially exposed and suspended above acid leaching mixture 36. Thus, the cutter element 1 does not directly contact the liquid acid mixture 36 during the leaching process of stage 1040.

In stage 1040, the temperature of the system 30 is elevated to begin to transition at least a portion of the acid leaching mixture 36 from a liquid to a vapour in the leaching receptacle 32. The temperature may be increased to the selected leaching temperature using any suitable technique or device known in the art. For example, a heat generating component may be coupled to or be placed in contact with the outer surface of the leaching chamber 32 such that heat generated by the heat generating component may increase the temperature within leaching receptacle 32. The temperature of the leaching receptacle 32 during the leaching process may be for example between around 100 to around 300° C., such as between around 140 to around 200 degrees C., or such as between around 145 to around 180 degrees C. in some examples.

During stage 1040, the acid vapour(s) of the acid leaching mixture 36 in the leaching receptacle 32 come into contact with the exposed body of PCD material 12 of the PCD cutter element 1 held within the fixture 38, but is/are restricted and/or prevented from contacting the substrate 10 via the sealing member 40.

Heating the leaching receptacle 32 and/or directly heating the acid leaching mixture 36 therein, and holding the acid leaching mixture 36 at a selected temperature during the leaching process may be advantageous as it is believed to assist in maintaining the integrity of the seal member 40.

In an aqueous leaching method, the cutter 1 is instead disposed in part in the liquid acid leaching mixture 36 and, once the apparatus is sealed as described above, the temperature within the leaching receptacle 32 may elevated such that the acid mixture 36 begins to boil and leach the body of PCD material 12 of the cutter element 1. The elevated temperature within the leaching receptacle 32 is maintained for a period of time to enable leaching of the body of PCD material 12 to the desired leach depth to be achieved. As with the vapour leaching technique, the temperature may be increased using any suitable technique or device known in the art. For example, a heat generating component may be coupled to or be placed in contact with the outer surface of the leaching chamber 32 such that heat generated by the heat generating component may increase the temperature within leaching receptacle 32. The temperature of the leaching receptacle 32 during the leaching process may be for example between around 40 to around 70° C. for aqueous acid leaching.

After exposure to the acid leaching mixture for the desired time, in step 1200 the body of PCD material 12 is rinsed to remove residual acid leaching mixture 36 therefrom. The rinsing step 1200 may include cooling the leaching receptacle 32 after the step of exposing the PCD cutter element to the acid 36, removing residual acid leach mixture 36 from the leaching receptacle 32, then rinsing with, for example, de-ionised water to remove residual acid leaching mixture from the PCD cutter element 1. The rinsing step 1200 may include introducing de-ionised water into the leaching receptacle 32, sealing the leaching receptacle 32 in the same manner as for the leaching process and elevating the temperature of the leaching receptable 32 and/or water therein for a period of time to rinse the PCD material. The rinsing step may be repeated with fresh water a number of times as desired or necessary. The necessity of this may be determined, for example, by testing the pH of the discarded water to determine its acidity. Multiple rinsing cycles may be needed to achieve a pH of 5 or above, which means that the sample is safe to handle (with PPE) before drying at, for example, between around 60 to around 90 degrees C. for several hours.

The preceding description has been provided to enable others skilled the art to best utilize various aspects described by way of example herein. This description is not intended to be exhaustive or to be limited to any precise form disclosed. Many modifications and variations are possible.

1. A method for leaching a polycrystalline diamond (PCD) cutter element having a non-diamond phase comprising a solvent catalyst material, the method comprising:
(a) providing a leaching receptacle having a first cavity therein and a second cavity therein, the first cavity extending from a first end of the leaching receptacle to a first open end of the second cavity, the second cavity extending from the first open end to a second end and being arranged to receive a volume of liquid acid leaching mixture;
(b) introducing a volume of liquid acid leaching mixture into the second cavity of the leaching receptacle;
(c) attaching the PCD cutter element to a fixture, the fixture being adapted to hold the PCD cutter element to be leached;
(d) positioning a seal member around a portion of the PCD cutter element to be leached;
and locating the seal member in a recess in the fixture;
(e) locating the PCD cutter element in the second cavity by passing the PCD cutter element attached to the fixture through the first end of the leaching receptacle and through the first cavity;
(f) connecting the fixture to the leaching receptacle, the step of connecting comprising compressing the seal member against and/or between the cutter and the leaching receptacle to form a closed system with the PCD cutter to be leached in the fixture forming a lid; and
(g) elevating the temperature of the liquid acid leaching mixture to above ambient conditions to leach at least a portion of the PCD cutter element.

2. The method of claim 1, wherein the step of elevating the temperature of the liquid acid leaching mixture to above ambient conditions comprises:
elevating the temperature to a temperature to transition at least some of the liquid acid leaching mixture to acid vapour(s); and
exposing the PCD cutter element to the acid vapour(s) to leach the PCD cutter element.

3. The method of claim 2, wherein the step of elevating the temperature of the liquid acid leaching mixture to above ambient conditions to transition at least some of the liquid acid leaching mixture to acid vapour(s) comprises heating the leaching mixture to between around 100 degrees C. to around 300 degrees C.

4. The method of claim 2, wherein the step of elevating the temperature of the liquid acid leaching mixture to above ambient conditions to transition at least some of the liquid acid leaching mixture to acid vapour(s) comprises heating the leaching mixture to between around 140 degrees C. to around 200 degrees C.

5. The method of claim 2, wherein the step of elevating the temperature of the liquid acid leaching mixture to above ambient conditions to transition at least some of the liquid acid leaching mixture to acid vapour(s) comprises heating the leaching mixture to between around 145 degrees C. to around 180 degrees C.

6. The method of claim 1, wherein the step of applying a seal member around the PCD cutter element comprises applying an o-ring seal around the PCD cutter element.

7. The method of claim 1, wherein the step of locating the fixture comprises locating the fixture to suspend the PCD cutter element above the acid leaching mixture, the PCD material of the cutter element facing the acid leaching mixture but being spaced therefrom.

8. The method of claim 1, wherein the step of introducing a volume of liquid acid leaching mixture into the leaching receptacle comprises introducing an acid leaching mixture comprising any one or more of hydrochloric (HCl) acid, hydrofluoric (HF) acid, nitric (HNO₃) acid, sulfuric (H₂SO₄) acid, and/or phosphoric (H₃PO₄) acid at a molar concentration of between around 4M to around 9M; and water.

9. The method of claim 1, wherein the step of introducing a volume of liquid acid leaching mixture into the leaching receptacle comprises introducing an acid leaching mixture comprising hydrofluoric acid at a molar concentration of between around 4M to around 9M; nitric acid at a molar concentration of between around 4M to around 9M; and water.

10. The method of claim 1, wherein the step of introducing a volume of liquid acid leaching mixture into the leaching receptacle comprises introducing an acid leaching mixture comprising hydrofluoric acid at a molar concentration of between around 5 M to around 7M; and nitric acid at a molar concentration of between around 6.7M to around 8M; and water.

11. The method of claim 8, wherein the water comprises de-ionized water.

12. The method of claim 1, wherein the seal member comprises a seal formed of a fluroelastomer and/or a perfluoroelastomeric compound.

13. The method of claim 1, wherein the recess comprises a groove shaped to comprise a stepped groove, or a tapered groove.

14. The method of claim 1, wherein any one or more of the leaching receptacle and the fixture comprises stainless steel.

15. The method of claim 1, further comprising providing a removable liner in the second cavity of the leaching receptacle, the step of introducing a volume of liquid acid leaching mixture into the second cavity comprising introducing the leaching mixture into the liner.

16. The method of claim 15, wherein the liner is formed of an acid resistant material.

17. The method of claim 16, wherein the liner is formed of a fluropolymer material.

18. The method of claim 1, wherein the fixture comprises a threaded portion extending around a peripheral side surface of the fixture, and the leaching receptacle comprises a threaded portion; wherein the step of connecting the fixture to the leaching receptacle comprises engaging the threaded portion of the fixture with the threaded portion of the leaching receptacle.

19. The method of claim 1, wherein the first end of the second cavity region is terminated in an annular flange against which the fixture is contactable.

20. The method of claim 1, further comprising providing a movable plug; and locating the movable plug in a further recess in the leaching receptacle.

21. The method of claim 1, further comprising cooling the leaching receptacle after the step of exposing the PCD cutter element to the acid vapour(s) to leach the PCD cutter element; removing residual acid leach mixture from the leaching receptacle; and rinsing the PCD cutter element to remove residual acid leaching mixture therefrom.

22-25. (canceled)
